(19) United States
(12) Patent Application Publication
(10) Pub. No.: US 2006/0218255 A1
(43) Pub. Date: Sep. 28, 2006

(54) A METHOD FOR OPERATING A COMPUTER SYSTEM

(75) Inventors: Hung-I Chan, Hsichih, Taipei County (TW); Chao-Ren Cheng, Hsichih, Taipei County (TW)

Correspondence Address: PAI PATENT & TRADEMARK LAW FIRM, 1001 FOURTH AVENUE, SUITE 3200, SEATTLE, WA, 98154, US

(73) Assignee: WELLSYN TECHNOLOGY, INC., Hsichih, Taipei County (TW)

(21) Appl. No.: 11/163,171

(22) Filed: Oct. 7, 2005

(30) Foreign Application Priority Data
Mar. 22, 2005 (TW) 94108821

(51) Int. Cl. G06F 15/177

(52) U.S. Cl. 709/220

(57) ABSTRACT

A method for operating a computer system is described. A remote device is initialized. The remote device sends data to a host computer, and a local device transmits an output signal. Once the output signal is detected and the remote device has stopped communicating with the host computer for a predetermined period of time, the local device is initialized.

### RELATED APPLICATIONS

The present application is based on, and claims priority from, Taiwan Application Serial Number 94108821, filed Mar. 22, 2005, the disclosure of which is hereby incorporated by reference herein in its entirety.

### BACKGROUND

1. Field of Invention

The present invention relates to a method for operating a computer system. More particularly, the present invention relates to a method of initializing peripherals for operating a computer system.

2. Description of Related Art

With the progress of the Internet and communications technology, utilization of the internet has become widespread in companies and among individuals. Users frequently access a substantial amount of data. Nowadays, most companies usually utilize servers for managing the access of all kinds of data. Generally speaking, servers often only accept requests from terminal computers and perform the corresponding data management actions. Thus, system managers usually utilize an intermediary module for managing a plurality of servers in the application of IKVM (internet keyboard/video/mouse). Each server is connected to an intermediary module via a keyboard signal line, an image signal line and a mouse signal line. The control terminal, equipped with a keyboard, a display, and a mouse, is capable of connecting to any server via the intermediary module, thus controlling and managing the servers. In addition, the control terminal may be coupled to the intermediary module via the Internet for the management and control of remote computers.

FIG. 1 shows a conventional IKVM system 100, which includes a host computer 110, an intermediary module 120 coupled to the host computer 110, a remote device 130 coupled to the intermediary module 120 via the internet 140, and a local device 150 coupled to the intermediary module 120. The intermediary module 120 for operating the host computer 110 switches between the remote device 130 and the local device 150 for coupling to the host computer 110 and receives the data transferred from the remote device 130 or the local device 150 for processing. However, the remote device 130 and the local device 150 sometimes are different types of devices. To prevent different data formats from causing a mistaken device identity or a system crash when the intermediary module 120 switches between the remote device 130 and the local device 150, the prior art intermediary module 120 first utilizes a transfer software for transforming different data formats into a single format, and then transmits data in the single format to the host computer 110. For example, the remote device 130 is a three-key mouse, such as a mouse with a left key, a right key, and a ball. The local device 150 is a four-key mouse, such as a mouse with a left key, a middle key, a right key, and a ball. The transfer software 160 of the intermediary module 120 transforms all kinds of mouse data formats (such as the format of a two-key mouse, the format of a three-key mouse, the format of a four-key mouse, and the format of a five-key mouse) into the data format of the two-key mouse. Namely, the data format of the left-key mouse and the data format of the right-key mouse will then be transferred to the host computer 110. The host computer 110 regards the remote device 130 and the local device 150 as a two-key mouse. Thus, when the intermediary module 120 switches between the remote device 130 and the local device 150, the host computer 110 does not cause a mistaken device identity or a system crash because of different data formats.

Generally speaking, because the remote device 130 transfers data to the intermediary module 120 via the Internet 140, the intermediary module 120 usually regards the remote device 130 as a data source. Thus, utilizing the transfer software 160 for transferring the data from the remote device 130 is necessary. However, following the foregoing example, the middle key and the ball (as well as other keys) of the local device 150 will lose their original function. Similarly, if the remote device 130 and the local device 150 are different types of keyboards and the transfer software 160 of the intermediary module 120 transforms different data types into the same format to be transmitted to the host computer 110, then the keyboard of the local device 150 sometimes cannot generate the correct characters.

### SUMMARY OF THE INVENTION

It is therefore an objective of the present invention to provide a method for operating computer systems in order to solve the foregoing problems.

The method of the invention for operating a computer system includes the following steps: a first device is initialized; the first device sends data to a host computer; a second device transmits an output signal; and the second device is initialized once the output signal is detected and the first device has stopped sending data to the host computer for a predetermined period of time.

The present invention discloses a computer system, having a host computer, a first device connected to the host computer, and a second device connected to the host computer. Once one of the first device and the second device has stopped communicating with the host computer for a predetermined period of time, the host computer initializes the other of the first device and the second device.

The present invention may further include an intermediary module, such as a KVM switch, through which a host computer is coupled to a first device and a second device. The intermediary module includes a control unit and a software. Once the control unit detects that one of the first device and the second device has stopped communicating with the host computer for a period of time, the intermediary module will prompt the host computer to initialize the other one of the first device and the second device.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a conventional IKVM system;

FIG. 2 is an IKVM system according to one preferred embodiment of this invention; and

FIG. 3 is a flow chart of the method of operating the IKVM system illustrated in FIG. 2.

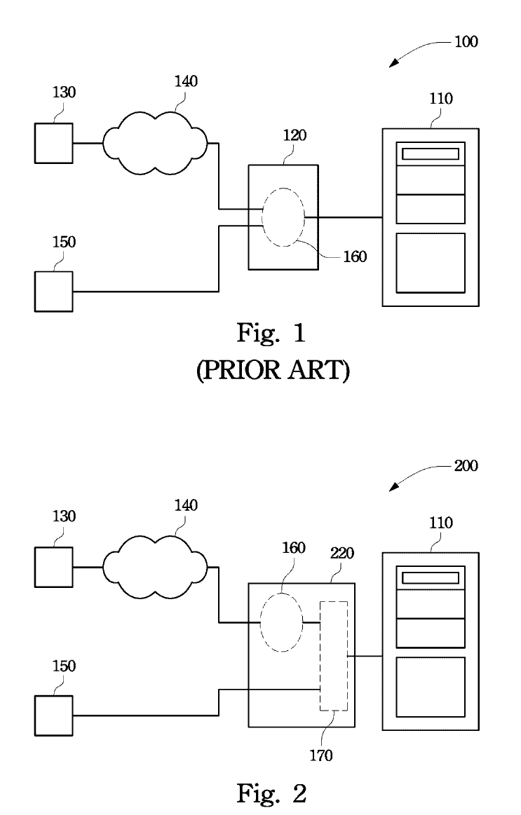

### DETAILED DESCRIPTION OF THE PREFERRED EMBODIMENTS

FIG. 2 illustrates an IKVM system 200 of the invention. The IKVM system 200 includes a host computer 110, an intermediary module 220 coupled to the host computer 110, a remote device 130 coupled to the intermediary module 220, and a local device 150 coupled to the intermediary module 220. In addition, the intermediary module 220 of the invention includes a software 160 for transforming the data format of the remote device 130; the intermediary module 220 also includes a control unit 170 for generating a control signal according to the signals transmitted from the remote device 130 or the local device 150. For solving the problems in prior art, when the intermediary module 220 switches to the local device 150 from the remote device 130, the control unit 170 of the intermediary module 220 will send a control signal to the host computer 110 to prompt the host computer 110 to re-initialize the local device 150. Thus, the host computer 110 does not have the problems of mistaken device identity and the local device 150 is capable of maintaining the functions of every key.

Specifically, when the user utilizes the remote device 130 to operate the host computer 110, the transfer software 160 of the intermediary module 220 first transforms the data from the remote device 130 into a specific data format, and then transmits the transformed data to the host computer 110. This continues until the user of the remote device 130 stops using the remote device 130 and the intermediary module 220 no longer receives data from the remote device 130. If the remote device 130 has stopped communicating with the host computer 110 for a predetermined period of time, and the keys of the local device 150 are triggered to transmit an output signal to the intermediary module 220, then the control unit 170 of the intermediary module 220 will send a control signal to the host computer 110 to prompt the host computer 110 to re-initialize the local device 150. Meanwhile, the host computer 110 transfers the control of the host computer 110 to the local device 150. Therefore, when the local device 150 operates the host computer 110, every key and every function will remain workable. On the contrary, if the local device 150 has stopped transferring data to the host computer 110 for a predetermined period of time and the remote device 130 is triggered to transmit an output signal to the intermediary module 220, then the control unit 170 of the intermediary module 220 will send another control signal to the host computer 110 to prompt the host computer 110 to re-initialize the remote device 130 and again transfer the control of the host computer 110 to the remote device 130. However, since the remote device 130 transfers its data format via the transfer software 160, the keys and the function of the remote device 130 are limited to the data formats defined by the transfer software.

In addition, if the remote device 130 is a mouse, the corresponding local device 150 is also a mouse. On the contrary, if the remote device 130 is a keyboard, the corresponding local device 150 is also a keyboard. The intermediary module 220 of the invention separately manages the signals of the mouse and the keyboard, and the mouse or the keyboard of the local device 150 is usually a PS2 device. The control unit 170 of the intermediary module 220 can be implemented by software, hardware, firmware, or any combinations of the three. Although the host computer 110 shown in FIG. 2 is remotely controlled only by a remote device 130, the host computer 110 of the IKVM system 200 can actually allow a plurality of remote devices to separately control the host computer 110 through the switch of the intermediary module 220. For example, when the remote device 130 and the local device 150 have both stopped transferring data for a predetermined period of time, and another remote device transmits an output signal to the intermediary module 220, then the control unit 170 of the intermediary module 220 will send a control signal to the host computer 110 to prompt the host computer 110 to re-initialize that remote device and transfer the control to the same.

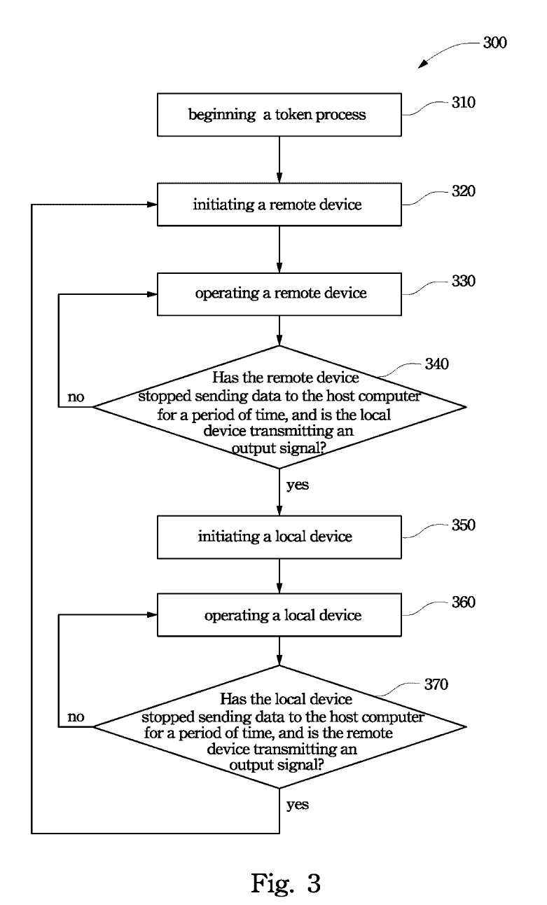

In conclusion, the flow chart 300 of FIG. 3 illustrates the method of operating the IKVM system 200 of this invention. With reference to FIG. 3, in step 310, a token process is initialized to provide the control of the host computer 110 to the remote 130 or the local device 150. Here it is assumed that at the beginning the control belongs to the remote device 130. Thus, in step 320, the host computer 110 initializes the remote device 130 to allow the remote device 130 to transfer data to the host computer 110 for processing. In step 330, the remote device 130 is operated to transfer data to the host computer 110. In the following step 340, the intermediary module 220 monitors the data flows simultaneously to check if the remote device 130 has stopped transferring data for a predetermined period of time and to detect if the local device 150 transmits an output signal. If either of the above conditions is not met, the process returns to step 330. If the above conditions are both met, the process continues to step 350. In step 350, the host computer 110 initializes the local device 150 to allow the local device 150 to transfer data to the host computer 110 for processing. In step 360, the local device 150 is operated to transfer data to the host computer 110. In step 370, the intermediary module 220 simultaneously monitors the data flows to check if the local device 150 has stopped transferring data to the host computer 110 for a predetermined period of time and to detect if the remote device 130 transmits an output signal. If either of the above conditions is not met, the process returns to step 360. If the above conditions are both met, then the process continues to step 320 to initialize the remote device 130, and repeats the steps described above. These steps need not proceed in the exact order described above, and other steps may be inserted into the sequence. Compared with the prior art, the invention provides a method for operating the computer system, in which the host computer 110 re-initializes the peripherals by turns so that the host computer 110 does not have the problem of mistaken device identity and the original functions of the local device 150 can be preserved.

It will be apparent to those skilled in the art that various modifications and variations can be made to the embodiments of the present invention without departing from the scope or spirit of the invention. In view of the foregoing, it is intended that the present invention covers modifications and variations of this invention provided they fall within the scope of the following claims and their equivalents.

What is claimed is:

1. A method for operating a computer system, comprising:
(a) initializing a first device;
(b) transferring data to a host computer from the first device;
(c) transmitting an output signal from a second device; and
(d) initializing the second device once the output signal from the second device is detected and the first device has stopped transferring data to the host computer for a predetermined period of time.

2. The method of claim 1, further comprising transferring data to the host computer from the second device.

3. The method of claim 1, further comprising:
transmitting an output signal from the first device; and
initializing the first device once the output signal from the first device is detected and the second device has stopped transferring data to the host computer for a predetermined period of time.

4. The method of claim 1, wherein the data from the first device is transferred to the host computer through an intermediary module in step (b), the output signal from the second device is transmitted to the intermediary module in step (c), and the intermediary module is used to detect the output signal from the second device, to check if the first device has stopped transferring data to the host computer for a predetermined period of time, and to inform the host computer to initialize the second device in step (d).

5. The method of claim 1, wherein the first device is a remote device.

6. The method of claim 1, wherein the second device is a local device.

7. A computer system capable of initializing peripherals, comprising:
an intermediary module for generating a control signal according to an input signal; and
a host computer coupled to the intermediary module, comprising a logic unit receiving the control signal from the intermediary module for initializing peripherals coupled to the intermediary module.

8. The computer system of claim 7, further comprising a peripheral coupled to the intermediary module for controlling operation of the host computer.

9. The computer system of claim 8, wherein the peripheral is coupled to the intermediary module through the Internet.

10. The computer system of claim 8, wherein the peripheral is a cursor device.

11. The computer system of claim 10, wherein the cursor device is a mouse.

12. The computer system of claim 8, wherein the peripheral is a keyboard.

13. The computer system of claim 8, wherein the peripheral is a PlayStation 2.

14. The computer system of claim 7, wherein the computer system is an IKVM system.

15. A computer system, comprising:
a host computer;
an intermediary module;
a first device connected to the host computer through the intermediary module; and
a second device connected to the host computer through the intermediary module;
wherein once one of the first device and the second device has stopped communicating with the host computer for a predetermined period of time, the host computer initializes the other one of the first device and the second device.

16. The computer system of claim 15, wherein the computer system is a KVM switch.

17. The computer system of claim 15, wherein the first device is a mouse.

18. The computer system of claim 15, wherein the second device is a mouse.

19. A KVM switch, through which a host computer is coupled to a first device and a second device, the KVM switch comprising:
a control unit; and
a software, which converts the format of data from the second device;
wherein once the control unit detects that one of the first device and the second device has stopped communicating with the host computer for a predetermined period of time, the host computer initializes the other one of the first device and the second device.
